(19) United States
(12) Patent Application Publication
(10) Pub. No.: US 2012/0067657 A1
(43) Pub. Date: Mar. 22, 2012

(54) HANDLE FOR A DOOR LEAF OF AN AUTOMOBILE

(75) Inventors: Guillaume Lesueur, Pianezza (IT); Fiorenzo Savant, Pianezza (IT); Antonio Rocci, Pianezza (IT)

(73) Assignee: VALEO S.P.A., Santena (TO) (IT)

(21) Appl. No.: 13/321,091

(22) PCT Filed: Jun. 4, 2010
(86) PCT No.: PCT/EP10/57828

§ 371 Date: Nov. 17, 2011

(30) Foreign Application Priority Data
Jun. 12, 2009 (IT) MI2009A001048

(51) Int. Cl. B60K 28/14

(52) U.S. Cl. 180/274

(57) ABSTRACT

The invention relates to a handle (1) of an openable body section of an automobile which includes: a gripping lever (3) rotatably movable between an inoperative position and a control position for opening a lock of the openable body section; a transmission lever (11) mounted in a base (5) of the handle, the transmission lever (11) being configured such as to be actuated by the gripping lever and to pivot between an inoperative position and an operative position for opening the lock; and a security system (17, 117) mounted in the base (5), configured to prevent the rotation of the transmission lever (11) or the gripping lever (3) in the event of a crash, the security system (17, 117) comprising at least one first inertial mass pivotably mounted between an inoperative position and an operative position preventing the rotation of the transmission lever or the gripping lever, when said first inertial mass is subjected to acceleration in the event of a crash, characterised in that said handle also comprises first (24) and second (25) additional means for blocking said inertial mass (17, 117) in the active position thereof, one of which is supported by said inertial mass (17, 117) and the other by the base (5).

The invention relates to a handle for a door leaf of an automobile, in particular a handle for a side door with an inertial security system.

To meet various safety standards, in particular in the event of a side collision, the side handles of an automobile which are currently known are provided with an inertial system. Said inertial system is triggered in the event of a side collision against the door and locks the gripping lever to prevent untimely opening of the side door which could cause the ejection of the passenger from the vehicle.

Said known handles comprise a gripping lever which is mobile in rotation relative to the door leaf between an inoperative position and a control position. Said gripping lever is able to act on a transmission lever which is intended to actuate the opening of a lock of the door leaf via a rod assembly or Bowden cables.

The inertial system consists in the known manner of an inertial body and locking lug fixed to said inertial body which cooperates with a shoulder of the transmission lever to lock said lever in the event of a side collision in a position in which it is not able to act to open the lock.

Such a handle is disclosed, for example, in the patent document WO2004/042177 in the name of the applicant. Said handle comprises a handle lever which is able to rotate about a first axis in a frame or base designed to be fixed to the door and is connected mechanically to a swivel wheel which is able to rotate in said frame about a second axis when the lever is pulled so as to open the door. The swivel wheel is provided with a shoulder capable of being intercepted by a stop piece forming part of a locking element comprising a lever of the rocker arm type which is provided with an inertial body and is articulated to the frame or to a body fixed to the frame so as to pivot about a third axis, such that in the event of violent pivoting of the rocker arm the stop piece strikes the shoulder and prevents the rotation of the swivel wheel. Said third axis of rotation of the rocker arm is substantially parallel to the first axis of rotation of the handle lever and the inertial body is arranged between said two axes of rotation.

Whilst such an arrangement has a relatively satisfactory result, it has been shown, however, that it poses the following technical problems.

In the event of a violent side collision against the door, it is apparent that the stresses suffered by the frame carrying the handle are of a very varied nature. Moreover, the constitution of the bodywork of the vehicle plays a significant role. For example, the hinge region of the handle lever which substantially corresponds to the middle of the door is a location which has little rigidity. In contrast, the other end of the handle lever is in the vicinity of a reinforced and rigid structure of the vehicle. Moreover, vibrations of the door panel ensue, which have an effect on the handle and thus on the rocker arm.

Thus the rocker arm may be subjected to a more rapid displacement than the other parts. Thus it may return to its inoperative position by the action of a reverse stress before the interception and locking of the shoulder of the swivel wheel at the start of the rotation thereof pulled by the lever. Its safety function is thus not fulfilled.

Moreover, in the event of such side collisions, if the displacement of the element suffering the impact is blocked after the collision, a separation results between said element and the vehicle which continues to be displaced, carried along by its inertia. If said element is now engaged with the handle lever with a considerable force which is greater than the force exerted by the rocker arm, the handle lever is then pulled and the door may be opened.

The document WO2006/003197, also in the name of the applicant, has provided a significant improvement to this problem. More specifically, said document proposes a door handle with an inertial system, which is also provided with a part for locking the inertial system when said inertial system is in its operative position.

However, the space requirement and production cost of this solution is not inconsiderable.

The present invention aims to remedy said drawbacks of the prior art by proposing a handle, the locking of the inertial security system thereof in the operative position being implemented at an optimal cost and with an optimal space requirement.

To this end, the subject of the invention is a handle for a door leaf of an automobile, comprising:
a gripping lever mobile between an inoperative position and a control position for opening a lock of the door leaf,
a transmission lever (11) mounted in a base (5) of the handle, the transmission lever (11) being configured so as to be actuated by the gripping lever and to pivot between an inoperative position and an operative position for opening the lock, and
a security system mounted in the base, configured to prevent the rotation of the transmission lever or the gripping lever in the event of a collision, the security system comprising at least one first inertial body pivoting between an inoperative position and an operative position, preventing the rotation of the transmission lever or the gripping lever when said first inertial body is subjected to an acceleration in the event of a collision,

characterized in that it also comprises first and second additional means for retaining said inertial body in the operative position thereof, one of said means being carried by said inertial body and the other by the base.

Said additional means for retaining said inertial body may thus be housed in the free space of the base of the handle provided for the movement of the inertial body.

The handle may further comprise one or more of the following features, taken separately or in combination:
the retaining means carried by the inertial body comprise a ring for fixing to said inertial body,
the retaining means carried by the inertial body comprise clip-on means for fixing to said inertial body,
the retaining means carried by the inertial body with its clip-on means for fixing are produced in the form of a clip attached to the inertial body,
the retaining means carried by the inertial body are produced from plastics material,
the retaining means carried by the inertial body comprise at least one elastically deformable retaining protuberance cooperating with the additional retaining means carried by the base,
the retaining means carried by the inertial body comprise two elastically deformable retaining protuberances arranged on opposing sides of the inertial body and cooperating with additional retaining means carried by the base,
said at least one retaining protuberance has the shape of a hook,
said at least one retaining protuberance is arranged in the vicinity of one end of maximum amplitude of movement of said inertial body in the event of a collision,
the retaining means carried by the base are made of the same material as the base,
the retaining means carried by the base are produced in the form of one or more hooks cooperating with the additional retaining means carried by the inertial body.

The handle may comprise:
a first inertial body configured to prevent in an operative position the rotation of the transmission lever or the gripping lever in a reversible manner, when said first inertial body is subjected to a first acceleration,
a second inertial body configured to prevent in an operative position the rotation of the transmission lever or the gripping lever, when said second inertial body is subjected to a second acceleration which is greater than the first acceleration,

the first and second additional retaining means being arranged to act on the second inertial body in the operative position thereof.

Further features and advantages of the invention will be revealed from the following description, provided by way of non-limiting example, with reference to the accompanying drawings, in which:

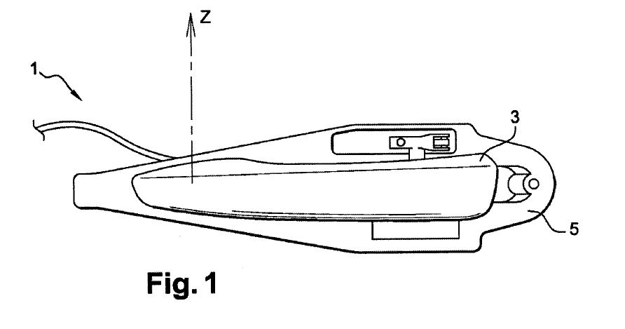

FIG. 1 shows a perspective view of a handle 1 for a door leaf of an automobile, in particular of a side door,

FIG. 2 shows a perspective view of the rear of a handle according to a first embodiment,

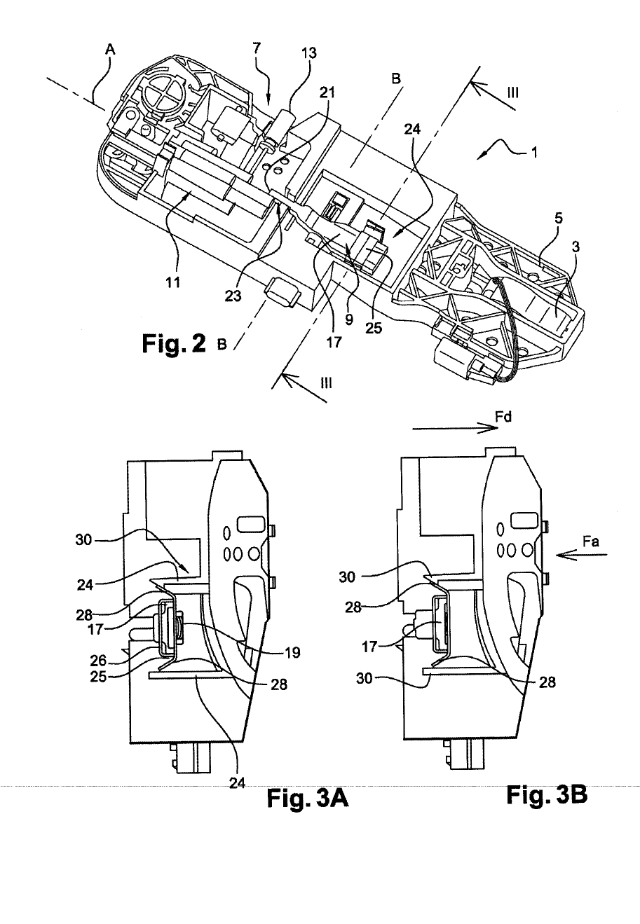

FIG. 3A is a sectional view along the line of FIG. 2 in an inoperative position of the inertial system,

FIG. 3B is a sectional view along the line of FIG. 2 in an operative position of the inertial system,

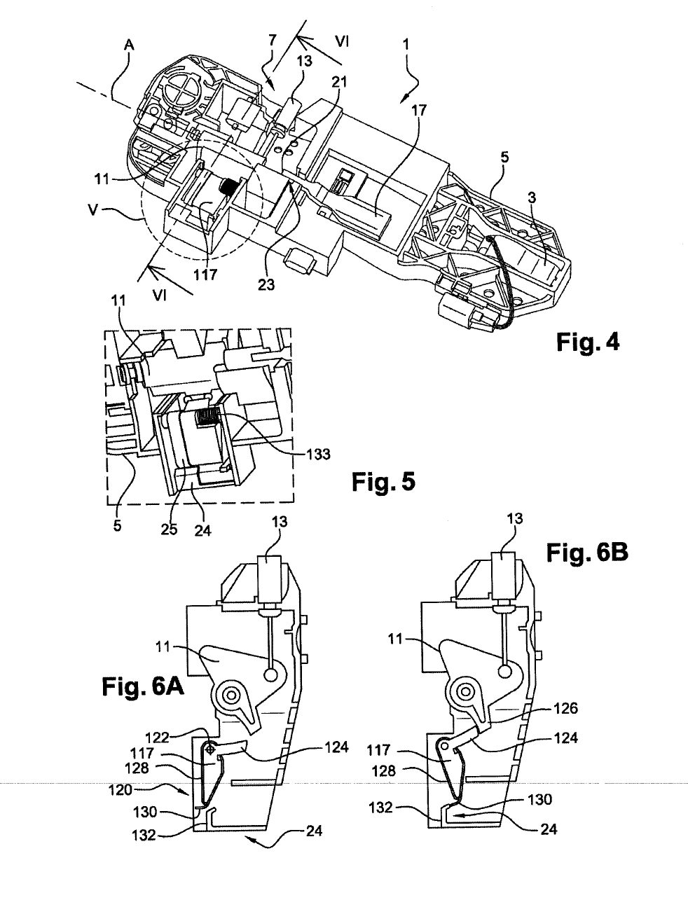

FIG. 4 shows a perspective view of the rear of a handle according to a second embodiment,

FIG. 5 is a perspective view of a detail IV of FIG. 4,

FIG. 6A is a sectional view along the line VI-VI of FIG. 4 in an inoperative position of the inertial system, and

FIG. 6B is a sectional view along the line VI-VI of FIG. 4 in an operative position of the inertial system.

FIG. 1 shows a perspective view of a handle 1 for a door leaf of an automobile, in particular of a side door.

The handle 1 for a door leaf comprises a gripping lever 3 which is accessible from the exterior of the vehicle and on which a user pulls toward the outside to open the door.

Said lever 3 is connected to a fixed part 5, also known as a base, frame or handle support, which is designed to be mounted inside the door, more specifically behind the external face of the door and which is thus not visible once mounted on the vehicle.

The handle 1 is in this case a handle of the “fridge” type and the gripping lever 3 is mobile in rotation relative to the base 5.

More specifically, the gripping lever 3 may pivot about a first axis of rotation Z between an inoperative position and a control position to open a lock of the door leaf when the user pulls on said gripping lever 3. Said first axis of rotation Z is substantially parallel to the axis of rotation of the door.

A first embodiment of said base 5 is shown in FIG. 2 showing a perspective view of the rear of the handle 1, in particular its base 5 according to a first embodiment.

The base 5 is, for example, produced by injection-molding in a plastics material or a die-cast metal.

The base 5 comprises a transmission mechanism 7 to connect the gripping lever 3 to the mechanism for opening the door and an inertial security system 9 to avoid untimely opening of the door leaf in the event of a collision.

The transmission mechanism 7 comprises a transmission lever 11 with a counterweight mounted in the housing of the base 5.

Said transmission lever 11 is pivotably mounted about a second axis of rotation A between an inoperative position and an operative position in which the transmission lever 11 actuates the opening of the lock.

Moreover, the transmission mechanism 7 is connected to an actuating cable connected to the mechanism of the door, more specifically to the lock (not shown). Thus, when the transmission lever 11 is displaced into its operative position, the cable actuates the opening of the lock.

Moreover, the inertial system 9 comprises an inertial body 17 articulated on the base 5 or a part fixed to said base 5. As seen in FIG. 2, the inertial body 17 extends along a horizontal axis, in this case the longitudinal axis of the gripping lever 3.

Said inertial body 17 is pivotably mounted, relative to the base 5, about a third axis of rotation B between an inoperative position and an operative position in which the transmission lever 11 is locked in rotation.

Alternatively, the inertial body may directly lock the gripping lever 3.

According to this first embodiment, said third axis of rotation B is substantially perpendicular to the second axis A and substantially parallel to the first axis of rotation Z.

Moreover, a restoring spring 19 (see FIG. 3A), for example of the helicoidal type, makes it possible to return the inertial body 17 to the inoperative position.

The inertial body 17 is designed to pivot when it is subjected to high acceleration, for example in the order of 80-100 G (1 G corresponds to 9.80665 m s⁻²).

Said inertial body 17 carries at one end a locking lug which cooperates with a shoulder 23 of the transmission lever 11 when the first inertial body 17 is pivoted.

During normal opening of the door, the transmission lever 11 is driven in rotation without the locking lug 21 coming into contact with the shoulder 23, the first inertial body 17 remaining immobile in the inoperative position (FIG. 3a).

Conversely, in the event of a collision, if the gripping lever 3 is subjected to a force which would open said gripping lever, the first inertial body 17 is also subjected to the same force such that the first inertial body 17 pivots, overcoming the force of the restoring spring. Said spring causes the locking lug 21 to be displaced until it intercepts the shoulder 23 and locks the transmission lever 11 at the start of the rotation of the transmission lever 11 (FIG. 3B).

In order to make the inertial body 17 secure in the operative position, the handle further comprises first and second 25 additional means for retaining said inertial body 17 in its operative position, one 25 of said means being carried by said inertial body 17 and the other 24 by the base 5.

For increased operating efficiency, the retaining means 24, 25 are arranged in the vicinity of one end of maximum amplitude of movement of said inertial body in the event of a collision, i.e. at the free end, opposing the lug 21.

According to the embodiment of FIGS. 2, 3A and 3B, the retaining means 25 carried by the inertial body 17 comprise a ring or sleeve 26 for fixing to said inertial body 17 in addition to at least two retaining protuberances 28 in FIGS. 2, 3A and 3B, in the form of fins or hooks which are elastically deformable and cooperate with additional retaining means 24 carried by the base 5. Said protuberances 28 are arranged on opposing sides of the inertial body 17.

According to one feature, the retaining means 25 carried by the inertial body 17 are produced from plastics material, for example by injection-molding. As a result, this is an inexpensive part which is easily mounted by slipping over the inertial body 17.

The retaining means 24 carried by the base are preferably made of the same material as the base and produced in the form of one or more hooks 30 cooperating with the additional retaining means 25 carried by the inertial body.

FIG. 3A shows the inertial body in addition to the retaining means 24, 25 in the inoperative position.

If the handle is subjected to significant acceleration (arrow Fa in FIG. 3B) as mentioned above, the inertial body 17 is displaced relative to the handle in the direction of the arrow Fd.

In this case, the fins 28 are elastically deformed so as to be housed at the end of travel behind the hooks 30 which prevent any vibration of the inertial body. The inertial body 17 thus remains effectively locked in its operative position for locking the transmission lever 11, thus securing against untimely opening of the door.

Reference is now made to the embodiment of FIGS. 4, 5 and 6A and 6B. The same elements carry the same reference numerals.

The handle 1 of FIG. 4 differs from that of FIG. 2 in that it comprises a first inertial body 17 in addition to a second inertial body 117.

In this embodiment, the first inertial body 17 functions as has been explained in relation to FIGS. 2, 3A and 3B, but is designed differently, to pivot when it is subjected to low acceleration, for example in the order of 15-20 G (1 G corresponds to 9.80665 m s⁻²).

Also, in contrast to the first embodiment, this time the first inertial body 17 is not locked in the operative position and, as a result, the transmission lever 11 is locked in a reversible manner.

The second inertial body 117 is arranged in the region of the location of the counterweight of the first embodiment.

Said second inertial body is dimensioned for high acceleration, for example in the order of 80-100 G. It thus fulfills the role fulfilled by the inertial body 17 of the first embodiment.

As seen in FIGS. 6A and 6B, the inertial body 117 has in cross section an elongated shape with a substantially triangular free end 120. Opposing this end 120, the inertial body 117 is articulated on an axis 122 substantially parallel to the axis A. The inertial body is held in the inoperative position by a spring, for example a helicoidal spring 123.

A lever 124 is fixed to the inertial body 117 and may adopt an inoperative position (FIG. 6A) in which the transmission lever 11 is not locked, or in the event of a collision an operative position (FIG. 6B) in which the lever 124 forms an abutment for a cam 126 fixed to the transmission lever, thus locking said transmission lever.

In this embodiment, the first 24 and second 25 additional retaining means are arranged to act on the second inertial body 117 in the operative position thereof.

In more detail, the retaining means 24 carried by the inertial body comprise clip-on means for fixing to said inertial body, for example made in the form of a clip 128 attached to the inertial body 117.

Said clip 128 further comprises a hook 130 which cooperates in the operative position with a hook 132 fixed to, and made of the same material as, the base 5.

In this embodiment, the clip 128 may be made of plastics material, as an individual part which is mounted on the inertial body or, for example, by overmolding.

Said hook 128 is an elastically deformable retaining protuberance and arranged as seen in the figures, in the vicinity of one end of maximum amplitude of movement of said inertial body 117 (i.e. the end 120) in the event of a collision.

Thus, in the event of a violent collision, the second inertial body 117 pivots, overcoming the force of the spring 123, which causes the lever 124 to be located opposite the cam 126, locking the transmission lever. Moreover, the hook 130 passes behind the hook 132, thus locking the inertial body 117 in its operative position.

Naturally, having been subjected to the collision, the security system of the handle may be deactivated to permit the opening of the door, for example in the case of intervention by firefighters following an accident.

1. A handle for a door leaf of an automobile, comprising:
a gripping lever mobile between an inoperative position and a control position for opening a lock of the door leaf;
a transmission lever mounted in a base of the handle, wherein the transmission lever is configured to be actuated by the gripping lever and to pivot between an inoperative position and an operative position for opening the lock;
a security system mounted in the base, configured to prevent the rotation of the transmission lever or the gripping lever in the event of a collision, the security system comprising at least one first inertial body pivoting between an inoperative position and an operative position, preventing the rotation of the transmission lever or the gripping lever when said at least one first inertial body is subjected to an acceleration in the event of the collision; and
first and second additional means for retaining said at least one first inertial body in the operative position thereof, one of said means being carried by said at least one first inertial body and the other by the base.

2. The handle as claimed in claim 1, wherein the second additional retaining means is carried by the inertial body and comprise a ring for fixing to said at least one first inertial body.

3. The handle as claimed in claim 1, wherein the second additional retaining means is carried by the inertial body and comprise clip-on means for fixing to said at least one first inertial body.

4. The handle as claimed in claim 3, wherein the second additional retaining means carried by the at least one first inertial body with the clip-on means for fixing are produced in the form of a clip attached to the at least one first inertial body.

5. The handle as claimed in claim 1, wherein the second additional retaining means is carried by the at least one first inertial body are produced from plastics material.

6. The handle as claimed in claim 1, wherein the second additional retaining means is carried by the at least one first inertial body and comprise at least one elastically deformable retaining protuberance cooperating with the first additional retaining means carried by the base.

7. The handle as claimed in claim 6, the second additional retaining means comprise two elastically deformable retaining protuberances arranged on opposing sides of the at least one first inertial body and cooperate with the first additional retaining means carried by the base.

8. The handle as claimed in claim 7, wherein at least one of the two retaining protuberances comprises a shape of a hook.

9. The handle as claimed in claim 7, wherein at least one of the two retaining protuberances is arranged in a vicinity of one end of maximum amplitude of movement of said at least one first inertial body in the event of the collision.

10. The handle as claimed in claim 1, wherein the first additional retaining means carried by the base are made of a same material as the base.

11. The handle as claimed in claim 1, wherein the first additional retaining means carried by the base are produced in a form of one or more hooks cooperating with the second additional retaining means carried by the at least one first inertial body.

12. The handle as claimed in claim 1, further comprising:
the at least one first inertial body configured to prevent, in the operative position, the rotation of the transmission lever or the gripping lever in a reversible manner, when said first inertial body is subjected to a first acceleration; and
a second inertial body configured to prevent, in the operative position, the rotation of the transmission lever or the gripping lever, when said second inertial body is subjected to a second acceleration greater than the first acceleration,
wherein the first and second additional retaining means are arranged to act on the second inertial body in the operative position thereof.
